(19) United States
(12) Patent Application Publication
(10) Pub. No.: US 2026/0045208 A1
(43) Pub. Date: Feb. 12, 2026

(54) DISPLAY DEVICE

(71) Applicant: Samsung Display Co., Ltd., Yongin-si (KR)

(72) Inventors: Hae Kwan SEO, Yongin-si (KR); Bon Seog GU, Yongin-si (KR); Hyoung Wook JANG, Yongin-si (KR)

(21) Appl. No.: 19/264,687

(22) Filed: Jul. 9, 2025

(30) Foreign Application Priority Data
Aug. 7, 2024 (KR) 10-2024-0105587

(51) Int. Cl. G09G 3/32; G09G 3/3233

(52) U.S. Cl. CPC G09G 3/32; G09G 3/3233; G09G 2310/08; G09G 2360/148

(57) ABSTRACT

A display device includes a display panel including a sub-pixel, and a light sensor for generating a sensing signal corresponding to an amount of received light, and a display panel driver for driving the display panel, for writing a data voltage to the sub-pixel in a first frame, and for receiving the sensing signal in a second frame.

### CROSS-REFERENCE TO RELATED APPLICATION

The present application claims priority to, and the benefit of, Korean Patent Application No. 10-2024-0105587, filed on Aug. 7, 2024, in the Korean Intellectual Property Office, the entire disclosure of which is incorporated herein by reference.

### BACKGROUND

### 1. Field

The present disclosure generally relates to a display device including a light sensor.

### 2. Description of the Related Art

With the development of information technologies, the importance of a display device which is a connection medium between a user and information increases. Accordingly, display devices, such as a liquid crystal display device and an organic light-emitting display device are increasingly used. In addition, the display devices may sense fingerprints of users and perform user authentication functions, using light sensors.

### SUMMARY

Embodiments provide a display device for reducing a sensing time of a light sensor.

Embodiments also provide a method of driving a display device, which drives the display device.

In accordance with an aspect of the present disclosure, there is provided a display device including a display panel including a sub-pixel, and a light sensor for generating a sensing signal corresponding to an amount of received light, and a display panel driver for driving the display panel, for writing a data voltage to the sub-pixel in a first frame, and for receiving the sensing signal in a second frame.

The data voltage may be not written in the second frame.

The sub-pixel may include a first pixel transistor for generating a driving current corresponding to the data voltage, an eighth pixel transistor for providing a bias voltage to the first pixel transistor in response to a bias gate signal, and a light-emitting element emitting light by receiving the driving current.

The light sensor may include a first sensing transistor for generating the sensing signal, a second sensing transistor for providing the sensing signal to a readout line in response to the bias gate signal, and a light-receiving element connected to a control electrode of the first sensing transistor.

The sub-pixel may include a first pixel transistor for generating a driving current corresponding to the data voltage in the first frame, a second pixel transistor for providing the data voltage to the first pixel transistor in response to a write gate signal in the first frame, and for providing a bias voltage to the first pixel transistor in response to the write gate signal in the second frame, and a light-emitting element for emitting light by receiving the driving current.

The light sensor may include a first sensing transistor for generating the sensing signal, a second sensing transistor for providing the sensing signal to a readout line in response to the write gate signal, and a light-receiving element connected to a control electrode of the first sensing transistor.

The light sensor may be configured to provide the sensing signal to the display panel driver in response to a gate signal, wherein the display panel includes a sensing area, and wherein the gate signal having an activation level is provided to the sensing area in the second frame.

The display panel driver may be configured to output the gate signal having the activation level to pixel lines in a first cycle in the first frame, and may be configured to output the gate signal having the activation level to the pixel lines in a second cycle, which is longer than the first cycle, in the second frame.

The sensing area may include pixel lines from an nth pixel line to an mth pixel line, wherein the gate signal having the activation level is applied to the pixel lines from the nth pixel line to the mth pixel line in the second frame.

The gate signal having the activation level may be applied to pixel lines from a first pixel line to an (n−1)th pixel line in the second frame.

Timings at which the gate signal having the activation level is applied to the nth pixel line in the first frame and in the second frame may be substantially the same.

A timing at which the gate signal having the activation level is applied to the nth pixel line in the second frame may be faster than a timing at which the gate signal having the activation level is applied to the nth pixel line in the first frame.

The sub-pixel may be configured to emit light in response to an emission signal, wherein the emission signal having a non-emission level is provided to the sensing area in the second frame.

The display panel driver may be configured to output the emission signal having a non-activation level to pixel lines in a first cycle in the first frame, and may be configured to output the emission signal having the non-activation level to the pixel lines in a second cycle, which is longer than the first cycle, in the second frame.

The sensing area may be closer to an opposite end, which is opposite to one end of the display panel, than to the one end, wherein the display panel driver is configured to scan pixel lines from a pixel line adjacent the opposite end.

The display panel driver may be configured to compensate for a luminance of the sensing area.

The display panel driver may be configured to receive the sensing signal of the sensing area of the display panel in the second frame, wherein the second frame is terminated upon termination of scanning of the sensing area.

A length of the first frame may be different from a length of the second frame.

A length of the first frame may be substantially equal to a length of the second frame.

A driving frame may include the first frame and multiple second frames including the second frame, wherein the display panel driver is configured to receive the sensing signal from at least one of the second frames.

In accordance with an aspect of the present disclosure, there is provided an electronic device including a display device including a display panel including a sub-pixel, and a light sensor for generating a sensing signal corresponding to an amount of received light, and a display panel driver for driving the display panel, for writing a data voltage to the sub-pixel in a first frame, and for receiving the sensing signal in a second frame.

The electronic device may include a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, a head-mounted display (HMD), a virtual reality (VR) device, or an augmented reality (AR) device.

### BRIEF DESCRIPTION OF THE DRAWINGS

Embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the embodiments to those skilled in the art.

FIG. 1 is a block diagram illustrating a display device in accordance with embodiments of the present disclosure.

FIG. 2 is a circuit diagram illustrating a sub-pixel and a light sensor of the display device shown in FIG. 1.

FIG. 3 is a conceptual diagram illustrating a driving operation of the display device shown in FIG. 1.

FIG. 4 is a diagram illustrating one or more embodiments in which the display device shown in FIG. 1 performs a sensing operation.

FIG. 5 is a timing diagram illustrating one or more embodiments in which the display device shown in FIG. 1 performs a display scan operation.

FIG. 6 is a timing diagram illustrating one or more embodiments in which the display device shown in FIG. 1 performs a self-scan operation.

FIG. 7 is a diagram illustrating a sensing area of the display device shown in FIG. 1.

FIG. 8 is a timing diagram illustrating a bias gate signal and an emission signal of the display device shown in FIG. 1.

FIG. 9 is a timing diagram illustrating a bias gate signal and an emission signal of a display device in accordance with embodiments of the present disclosure.

FIG. 10 is a timing diagram illustrating a bias gate signal and an emission signal of a display device in accordance with embodiments of the present disclosure.

FIG. 11 is a diagram illustrating a length of a frame of a display device in accordance with embodiments of the present disclosure.

FIG. 12 is a circuit diagram illustrating a sub-pixel and a light sensor of a display device in accordance with embodiments of the present disclosure.

FIG. 13 is a timing diagram illustrating one or more embodiments in which the display device shown in FIG. 12 performs a display scan operation.

FIG. 14 is a timing diagram illustrating one or more embodiments in which the display device shown in FIG. 12 performs a self-scan operation.

FIG. 15 is a block diagram illustrating an electronic device in accordance with embodiments of the present disclosure.

FIG. 16 is a diagram illustrating one or more embodiments in which the electronic device shown in FIG. 15 is implemented as a smartphone.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing one or more embodiments corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B”may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

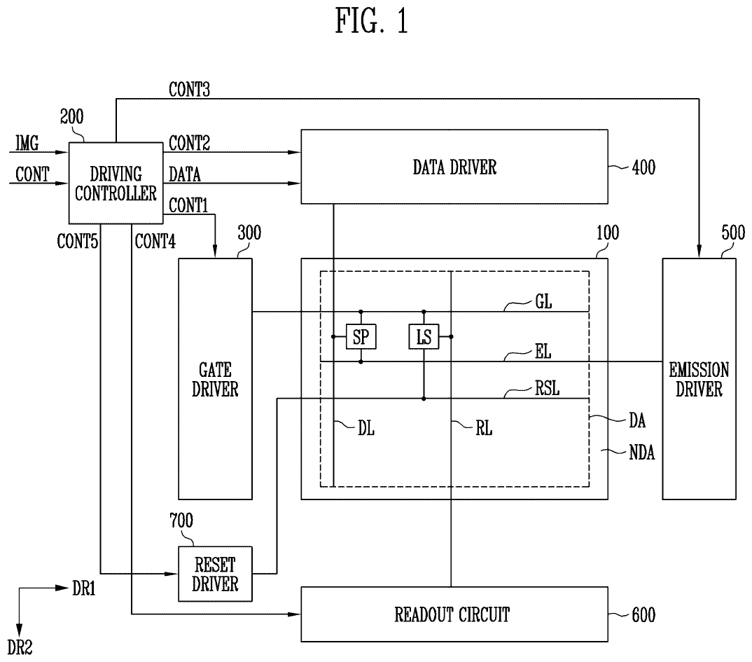

FIG. 1 is a block diagram illustrating a display device in accordance with embodiments of the present disclosure.

Referring to FIG. 1, the display device may include a display panel 100 and a display panel driver. The display panel driver may include a driving controller 200, a gate driver 300, a data driver 400, an emission driver 500, a readout circuit 600, and a reset driver 700. In one or more embodiments, the driving controller 200 and the data driver 400, may be integrated into one chip.

The display panel 100 may include a display area DA in which an image is displayed and a non-display area NDA located adjacent to the display area DA. In one or more embodiments, the gate driver 300 and the emission driver 500 may be mounted in the non-display area NDA.

The display panel 100 may include a plurality of gate lines GL, a plurality of data lines DL, a plurality of emission lines EL, and a plurality of sub-pixels SP electrically connected to the gate lines GL, the data lines DL, and the emission lines EL. The gate lines GL and the emission lines EL may extend in a first direction DR1, and the data lines DL may extend in a second direction DR2 crossing the first direction DR1.

The display panel 100 may include a plurality of gate lines GL, reset lines RSL, a plurality of readout lines RL, and a plurality of light sensors LS electrically connected to the gate lines GL, the reset lines RSL, and the readout lines RL.

In these embodiments, the reset lines RSL may be connected to the reset driver 700. However, the present disclosure is not limited thereto. For example, the reset lines RSL may be driven by the gate driver 300 or the emission driver 500 instead of the reset driver 700.

The driving controller 200 may receive input image data IMG and an input control signal CONT from a processor (e.g., a graphic processing unit (GPU) or the like). For example, the input image data IMG may include red image data, green image data, and blue image data. In one or more embodiments, the input image data IMG may further include white image data. In another example, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, a fifth control signal CONT5, and a data signal DATA, based on the input image data IMG and the input control signal CONT.

The driving controller 200 may generate the first control signal CONT1 for controlling an operation of the gate driver 300, based on the input control signal CONT, and may output the first control signal CONT1 to the gate driver 300. The first control signal CONT1 may include a vertical start signal and a gate clock signal.

The driving controller 200 may generate the second control signal CONT2 for controlling an operation of the data driver 400, based on the input control signal CONT, and may output the second control signal CONT2 to the data driver 400. The second control signal CONT2 may include a horizontal start signal and a load signal.

The driving controller 200 may generate the data signal DATA by receiving the input image data IMG and the input control signal CONT. The driving controller 200 may output the data signal DATA to the data driver 400.

The driving controller 200 may generate the third control signal CONT3 for controlling an operation of the emission driver 500, based on the input control signal CONT, and may output the third control signal CONT3 to the emission driver 500. The third control signal CONT3 may include a vertical start signal and an emission clock signal.

The driving controller 200 may generate the fourth control signal CONT4 for controlling an operation of the readout circuit 600, based on the input control signal CONT, and may output the fourth control signal CONT to the readout circuit 600.

The driving controller 200 may generate the fifth control signal CONT5 for controlling an operation of the reset driver 700, based on the input control signal CONT, and may output the fifth control signal CONT5 to the reset driver 700.

The gate driver 300 may generate gate signals for driving the gate lines GL connected to the plurality of sub-pixels SP and the gate lines GL connected to the plurality of light sensors LS in response to the first control signal CONT1 input from the driving controller 200. The gate driver 300 may output the gate signals to the gate lines GL connected to the plurality of sub-pixels SP and the gate lines GL connected to the plurality of light sensors LS. For example, the gate driver 300 may sequentially output the gate signals to the gate lines GL connected to the plurality of sub-pixels SP and the gate lines GL connected to the plurality of light sensors LS.

The data driver 400 may receive the second control signal CONT and the data signal DATA, which are input from the driving controller 200. The data driver 400 may generate data voltages obtained by converting the data signal DATA into a voltage in an analog form. The data driver 400 may output the data voltages to the data lines DL.

The emission driver 500 may generate emission signals for driving the emission lines EL in response to the third control signal CONT3 input from the driving controller 200. The emission driver 500 may output the emission signals to the emission lines EL. For example, the emission driver 500 may sequentially output the emission signals to the emission lines EL.

The readout circuit 600 may generate sensing information based on sensing signals received from the readout lines RL in response to the fourth control signal CONT4 input from the driving controller 200. For example, the readout circuit 600 may generate the sensing information by analog-to-digital converting the sensing signals. For example, the sensing information may correspond to a fingerprint image. The processor or the driving controller 200 may perform a user authentication function, using the sensing information provided from the readout circuit 600.

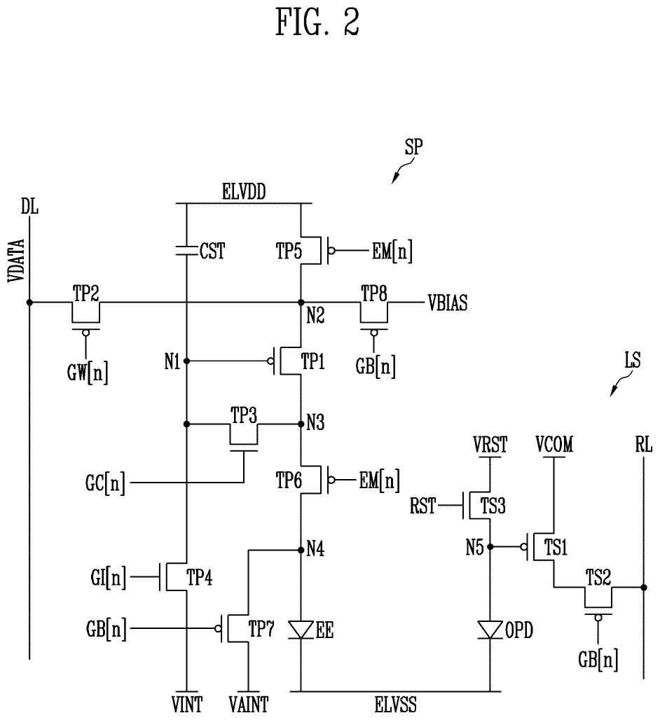

The reset driver 700 may provide a reset signal RST (see FIG. 2) to the reset lines RSL in response to the fifth control signal CONT5 input from the driving controller 200. In one or more embodiments, the reset driver 700 may commonly connected to all the light sensors LS through a reset line RSL. In one or more other embodiments, the reset driver 700 may be connected to the light sensors LS respectively through a plurality of reset lines RSL.

Each sub-pixel SP may include a light-emitting element. The light-emitting element may be a light-emitting diode. The light-emitting element may be configured as an organic light-emitting diode, an inorganic light-emitting diode, a quantum dot/well light-emitting diode, or the like. The light-emitting element may emit light of any one color among a first color, a second color, and a third color.

Each light sensor LS may include a light-receiving element. In one or more embodiments, the light-emitting element may be a photo diode. In one or more other embodiments, the light-receiving element may be configured as a photo transistor.

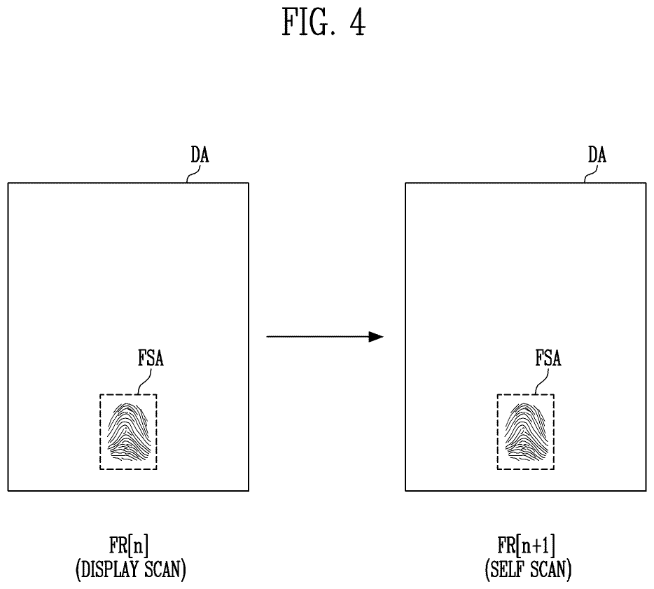

In one or more embodiments, the light sensors LS may be located in the entire area of the display area DA. In one or more other embodiments, the light sensors may be located in a sensing area FSA (see FIG. 4) in which sensing is performed in the display area DA or a partial area including the sensing area FSA (see FIG. 4).

Light emitted from a light-emitting element may be reflected by a fingerprint of a user to be applied to a light-receiving element adjacent to the light-emitting element. In addition, the light sensor LS may generate a sensing signal corresponding to an amount of the light applied to the light-receiving element. The processor or the driving controller 200 may distinguish a valley and a ridge of the fingerprint from each other according to an intensity of the sensing signal, and accordingly obtain a fingerprint image of the user.

FIG. 2 is a circuit diagram illustrating the sub-pixel and the light sensor of the display device shown in FIG. 1.

FIG. 2 illustrates a sub-pixel SP and a light sensor LS of an nth pixel line. A pixel line is determined with respect to a gate line GL, and a sub-pixel SP and a light sensor LS, which are connected to the same pixel line, are connected to the same gate line GL. Here, n is a positive integer.

Referring to FIG. 2, the sub-pixel SP may include a first pixel transistor TP1 generating a driving current corresponding to a data voltage VDATA, an eighth pixel transistor TP8 providing a bias voltage VBIAS to the first pixel transistor TP1 in response to a bias gate signal GB[n], and a light-emitting element EE emitting light by receiving the driving current.

For example, the sub-pixel SP may include the first pixel transistor TP1 (e.g., a driving transistor) including a control electrode connected to a first node N1, a first electrode connected to a second node N2, and a second electrode connected to a third node N3, a second pixel transistor TP2 including a control electrode receiving a write gate signal GW[n], a first electrode connected to a data line DL, and a second electrode connected to the second node N2, a third pixel transistor TP3 including a control electrode receiving a compensation gate signal GC[n], a first electrode connected to the third node N3, and a second electrode connected to the first node N1, a fourth pixel transistor TP4 including a control electrode receiving an initialization gate signal GI[n], a first electrode receiving a first initialization voltage VINT, and a second electrode connected to the first node N1, a fifth pixel transistor TP5 including a control electrode receiving an emission signal EM[n], a first electrode receiving a first power voltage ELVDD (e.g., a high power voltage), and a second electrode connected to the second node N2, a sixth pixel transistor TP6 including the emission signal EM[n], a first electrode connected to the third node N3, and a second electrode connected to a fourth node N4, a seventh pixel transistor TP7 including a control electrode receiving the bias gate signal GB[n], a first electrode receiving a second initialization voltage VAINT, and a second electrode connected to the fourth node N4, the eighth pixel transistor TP8 including a control electrode receiving the bias gate signal GB[n], a first electrode receiving the bias voltage VBIAS, and a second electrode connected to the second node N2, a storage capacitor CST including a first electrode receiving the first power voltage ELVDD and a second electrode connected to the first node N1, and the light-emitting element EE including a first electrode (e.g., an anode electrode) connected to the fourth node N4 and a second electrode (e.g., a cathode electrode) receiving a second power voltage ELVSS (e.g., a low power voltage). However, the present disclosure is not limited to the structure of the sub-pixel SP.

The first, second, fifth, sixth, seventh, and eighth pixel transistors TP1, TP2, TP5, TP6, TP7, and TP8 may be implemented with a p-channel metal oxide semiconductor (PMOS) transistor, and the third and fourth pixel transistors TP3 and TP4 may be implemented with an n-channel metal oxide semiconductor (NMOS) transistor. In the case of the PMOS transistor, a low voltage level may be an activation level, and a high voltage level may be a non-activation level. For example, when a signal applied to a control electrode of the PMOS transistor has the low voltage level, the PMOS transistor may be turned on. For example, when the signal applied to the control electrode of the PMOS transistor has the high voltage level, the PMOS transistor may be turned off. In the case of the NMOS transistor, a low voltage level may be a non-activation level, and a high voltage level may be an activation level. For example, when a signal applied to a control electrode of the NMOS transistor has the low voltage level, the NMOS transistor may be turned off. For example, when the signal applied to the control electrode of the NMOS transistor has the high voltage level, the NMOS transistor may be turned on. That is, the activation level and the non-activation level may be determined according to the kind of transistor. However, the pixel transistors in accordance with the present disclosure are not limited to any one of NMOS and PMOS.

The light sensor LS may generate a sensing signal corresponding to an amount of received light. The light sensor LS may include a first sensing transistor TS1 generating a sensing signal corresponding to an amount of received light, a second sensing transistor TS2 providing the sensing signal to a readout line RL in response to the bias gate signal GB[n], and a light-receiving element OPD connected to a control node of the first sensing transistor TS1. The light sensor LS may include a third sensing transistor TS3 initializing the control node of the first sensing transistor TS1 in response to a reset signal RST.

For example, the first sensing transistor TS1 may include the control electrode connected to a fifth node N5, a first electrode receiving a common voltage VCOM, and a second electrode connected to a first electrode of the second sensing transistor TS2, the second sensing transistor TS2 may include a control electrode for receiving the bias gate signal GB[n], the first electrode connected to the second electrode of the first sensing transistor TS1, and a second electrode connected to the readout line RL, and the light-receiving element OPD may include a first electrode connected to the fifth node N5 and a second electrode receiving the second power voltage ELVSS. The third sensing transistor TS3 may include a control electrode receiving the reset signal RST, a first electrode receiving a reset voltage VRST, and a second electrode connected to the fifth node N5.

For example, in a reset period, the reset signal RST may have an activation level, and the bias gate signal GB[n] may have a non-activation level. Accordingly, the third sensing transistor TS3 may be turned on, and the second sensing transistor TS2 may be turned off. In addition, the reset voltage VRST may be applied to the fifth node N5. That is, the fifth node N5 and the first electrode of the light-receiving element OPD may be initialized.

For example, in a light-receiving period, the reset signal RST and the bias gate signal GB[n] may have a non-activation level. Accordingly, the second sensing transistor TS2 and the third sensing transistor TS3 may be turned off. In addition, when light is applied, the light-receiving element OPD may generate a current in a direction facing the fifth node N5, and a voltage of the fifth node N5 may be decreased. Accordingly, the intensity of a sensing signal generated in a sensing-on period which will be described later may vary. In addition, because the amount of light applied to the light-receiving element OPD varies according to a valley and a ridge of a fingerprint, the intensity of the sensing signal may vary according to the valley and the ridge of the fingerprint.

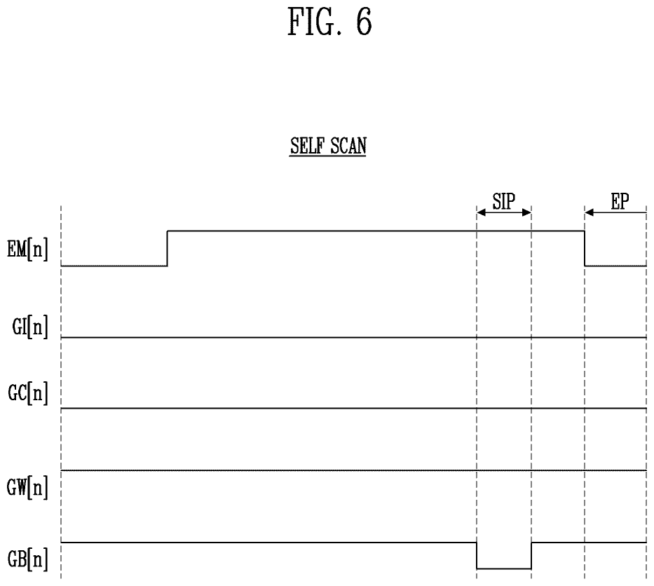

For example, in the sensing-on period (e.g., a sensing initialization period SIP (see FIG. 6) which will be described later), the reset signal RST may have a non-activation level, and the bias gate signal GB[n] may have an activation level. Accordingly, the second sensing transistor TS2 may be turned on, and the third sensing transistor TS3 may be turned off. In addition, the first sensing transistor TS1 may generate a sensing signal corresponding to a gate-source voltage. The sensing signal may be applied to the readout circuit through the readout line RL.

The first and second sensing transistors TS1 and TS2 may be implemented with a PMOS transistor, and the third sensing transistor TS3 may be implemented with an NMOS transistor. However, the sensing transistors in accordance with the present disclosure are not limited to any one of NMOS and PMOS.

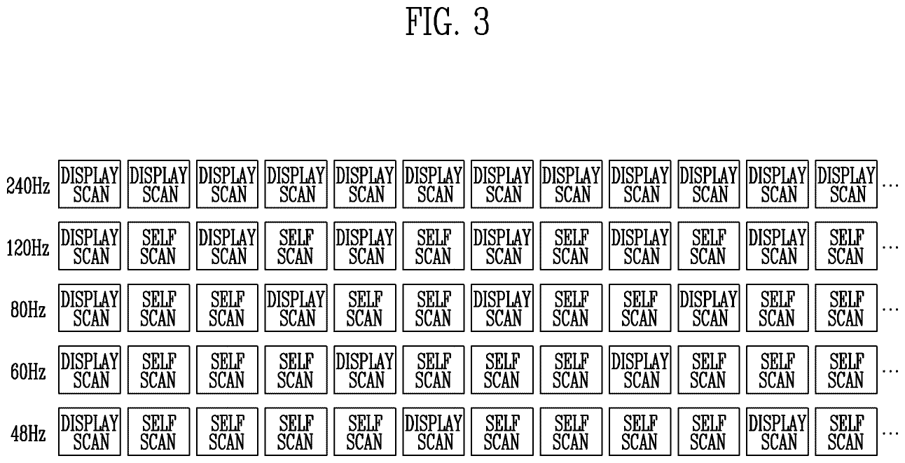

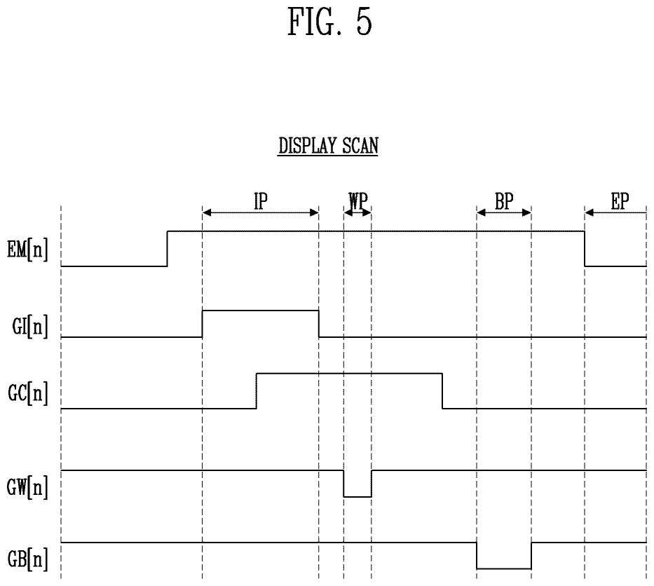

FIG. 3 is a conceptual diagram illustrating a driving operation of the display device shown in FIG. 1. FIG. 4 is a diagram illustrating one or more embodiments in which the display device shown in FIG. 1 performs a sensing operation. FIG. 5 is a timing diagram illustrating one or more embodiments in which the display device shown in FIG. 1 performs a display scan operation. FIG. 6 is a timing diagram illustrating one or more embodiments in which the display device shown in FIG. 1 performs a self-scan operation.

Referring to FIGS. 1 to 3, a display scan operation DISPLAY SCAN or a self-scan operation SELF SCAN may be performed in one frame. When the display scan operation DISPLAY SCAN is performed, an operation of writing a data voltage VDATA may be performed. When the self-scan operation SELF SCAN is performed, an emission operation may be performed without writing of the data voltage VDATA.

A display scan operation DISPLAY SCAN of one frame may be continuously repeated at a maximum driving frequency of the display panel 100 (e.g., when a driving frequency is about 240 Hz). The display scan operation DISPLAY SCAN of one frame may be set to one driving frame.

The display scan operation DISPLAY SCAN of one frame may be performed at driving frequencies (e.g., 120 Hz, 80 Hz, 60 Hz, and 48 Hz) except the maximum driving frequency of the display panel 100 (e.g., in FIG. 3, it is assumed that the maximum driving frequency is about 240 Hz), and a self-scan operation SELF SCAN may be performed in at least one frame.

For example, when the driving frequency is about 120 Hz, a display scan operation DISPLAY SCAN of one frame and a self-scan operation SELF SCAN of one frame may be repeated. The display scan operation DISPLAY SCAN of one frame and the self-scan operation SELF SCAN of one frame may constitute one driving frame (e.g., the same image may be displayed during the one driving frame).

If the driving frequency is about 80 Hz, a display scan operation DISPLAY SCAN of one frame and a self-scan operation SELF SCAN of two frames may be repeated. The display scan operation DISPLAY SCAN of one frame and the self-scan operation SELF SCAN of two frames may constitute one driving frame.

If the driving frequency is about 60 Hz, a display scan operation DISPLAY SCAN of one frame and a self-scan operation SELF SCAN of three frames may be repeated. The display scan operation DISPLAY SCAN of one frame and the self-scan operation SELF SCAN of three frames may constitute one driving frame.

If the driving frequency is about 48 Hz, a display scan operation DISPLAY SCAN of one frame and a self-scan operation SELF SCAN of four frames may be repeated. The display scan operation DISPLAY SCAN of one frame and the self-scan operation SELF SCAN of four frames may constitute one driving frame.

As such, the driving controller 200 may vary the driving frequency in a manner that adjusts the length of a period in which the self-scan operation SELF SCAN is performed.

An operation of generating sensing information by receiving a sensing signal (e.g., a sensing operation) in a frame in which the self-scan operation SELF SCAN is performed. This will be described in detail later.

Referring to FIGS. 3 and 4, a sensing area FSA may be displayed in the display area DA before a sensing operation is performed. For example, in the case of a sensing operation for sensing a fingerprint, a shape of the fingerprint may be displayed in the sensing area FSA. In addition, when the sensing operation is performed, a change in image displayed in the display area DS may be little.

Accordingly, the display panel 100 may be driven at a low frequency. The low frequency may be any one of the driving frequencies except the maximum driving frequency.

For example, when the sensing operation is performed, the sensing area FSA may be displayed in the display area DA in an nth frame FR[n] in which a display scan operation DISPLAY SCAN is performed, and the sensing operation may be performed in an (n+1)th frame FR[n+1] in which a self-scan operation SELF SCAN is performed.

Referring to FIG. 5, the frame in which the display scan operation DISPLAY SCAN is performed may include an initialization period IP, a writing period WP, a bias period BP, and an emission period EP.

In the initialization period IP, the initialization gate signal GI[n] may have an activation level, and the fourth pixel transistor TP4 may be turned on. Accordingly, the first initialization voltage VINT may be applied to the first node N1. That is, the control electrode of the first pixel transistor TP1 (e.g., the storage capacitor CST) may be initialized.

In the writing period WP, the write gate signal GW[n] and the compensation gate signal GC[n] may have an activation level, and the second pixel transistor TP2 and the third pixel transistor TP3 may be turned on. Accordingly, a data voltage VDATA may be written in the storage capacitor CST.

In the bias period BP, the bias gate signal GB[n] may have an activation level, and the seventh pixel transistor TP7 and the eighth pixel transistor TP8 may be turned on. Accordingly, the second initialization voltage VAINT may be applied to the first electrode (e.g., the anode electrode) of the light-emitting element EE, and the bias voltage VBIAS may be applied to the first pixel transistor TP1.

The sub-pixel SP may emit light in response to the emission signal EM[n]. In the emission period EP, the emission signal EM[n] may have an activation level, and the fifth pixel transistor TP5 and the sixth pixel transistor TP6 may be turned on.

Accordingly, the first power voltage ELVDD may be applied to the first pixel transistor TP1 such that a driving current is generated, and the driving current may be applied to the light-emitting element EE. That is, the light-emitting element EE may emit light with a luminance corresponding to the driving current.

Referring to FIG. 6, the frame in which the self-scan operation SELF SCAN is performed may include a sensing initialization period SIP and an emission period EP.

In the sensing initialization period SIP, the bias gate signal GB[n] may have an activation level, and the seventh and eighth pixel transistors TP7 and TP8 may be turned on. Accordingly, the second initialization voltage VAINT may be applied to the first electrode (e.g., the anode electrode) of the light-emitting element EE, and the bias voltage VBIAS may be applied to the first pixel transistor TP1.

In the sensing initialization period SIP, the bias gate signal GB[n] may have an activation level, and the second sensing transistor TS2 may be turned on. Accordingly, a sensing signal may be transferred to the readout line RL. In addition, the readout circuit 600 (see FIG. 1) may generate sensing information, based on the received sensing signal.

In the emission period EP, the emission signal EM[n] may have an activation level, and the fifth pixel transistor TP5 and the sixth pixel transistor TP6 may be turned on. Accordingly, the first power voltage ELVDD may be applied to the first pixel transistor TP1 such that a driving current is generated, and the driving current may be applied to the light-emitting element EE. That is, the light-emitting element EE may emit light with a luminance corresponding to the driving current.

As such, the display device may perform a sensing operation through the bias gate signal GB[n] which has no influence on the data voltage VDATA written in the sub-pixel SP in the frame in which the self-scan operation SELF SCAN is performed. Accordingly, influence which the sensing operation has on the sub-pixel SP can be reduced or minimized.

Also, the display device may perform the sensing operation in the frame in which the self-scan operation SELF SCAN is performed, so that a sensing time of the light sensor LS (see FIG. 1) can be reduced.

For example, for convenience of description, it is assumed that a time of about 4 □ is suitable for the readout circuit 600 (see FIG. 1) to convert a sensing signal into sensing information, the display panel driver scans pixel lines in a cycle of 1 □, and the sensing area FSA (see FIG. 4) is configured with 8 pixel lines. When a sensing operation is performed in the frame in which the display scan operation DISPLAY SCAN is performed, a sensing operation on a fifth pixel line of the sensing area FSA (see FIG. 4) may be performed after a sensing operation on a first pixel line of the sensing area FSA (see FIG. 4) is performed (e.g., after the time of about 4 □ elapses). That is, four frames may be suitable to perform a sensing operation on the entire sensing area FSA (see FIG. 4). However, in the present disclosure, the sensing operation on the entire sensing area FSA (see FIG. 4) is performed during a frame in which one self-scan operation SELF SCAN is performed, so that the sensing time can be reduced. This is the same as a case where the sensing operation on the entire sensing area FSA (see FIG. 4) is performed during a frame in which two or three self-scan operations SELF SCAN are performed.

When the display panel driver scans pixel lines in the cycle of 1 □, the display panel driver may output the gate signals GI[n], GC[n], GW[n], GB[n], and the emission signal EM[n], which have an activation level, to the first pixel line, and may output the gate signals GI[n], GC[n], GW[n], and GB[n], which have an activation level, to a second pixel line are provided to the (n+1)th pixel line PL[n+1] after a time of about 1 □ elapses.

In the frame in which the display scan operation DISPLAY SCAN is performed, that the display panel driver scans pixel lines mean that operations in the initialization period IP, the writing period WP, and the bias period BP, which are shown in FIG. 5, are performed. In the frame in which the self-scan operation SELF SCAN is performed, reference to the display panel driver scanning pixel lines may mean that an operation of the sensing initialization period SIP shown in FIG. 6 is performed.

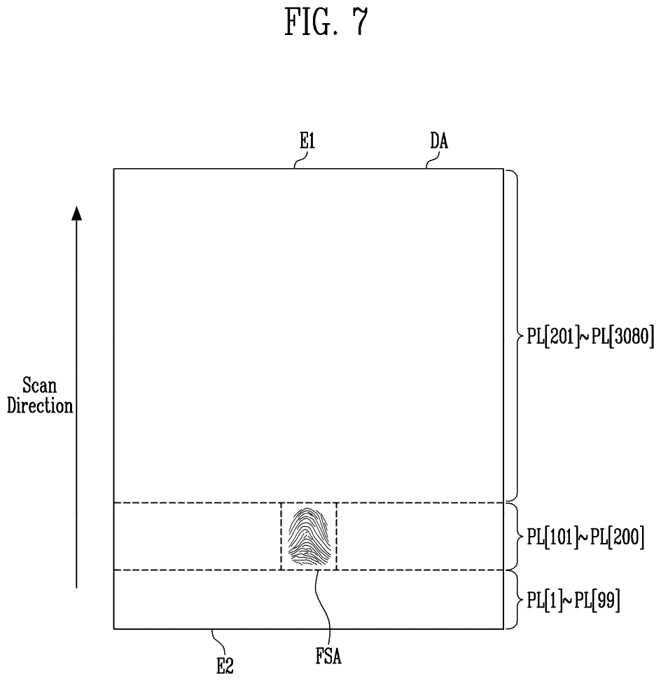

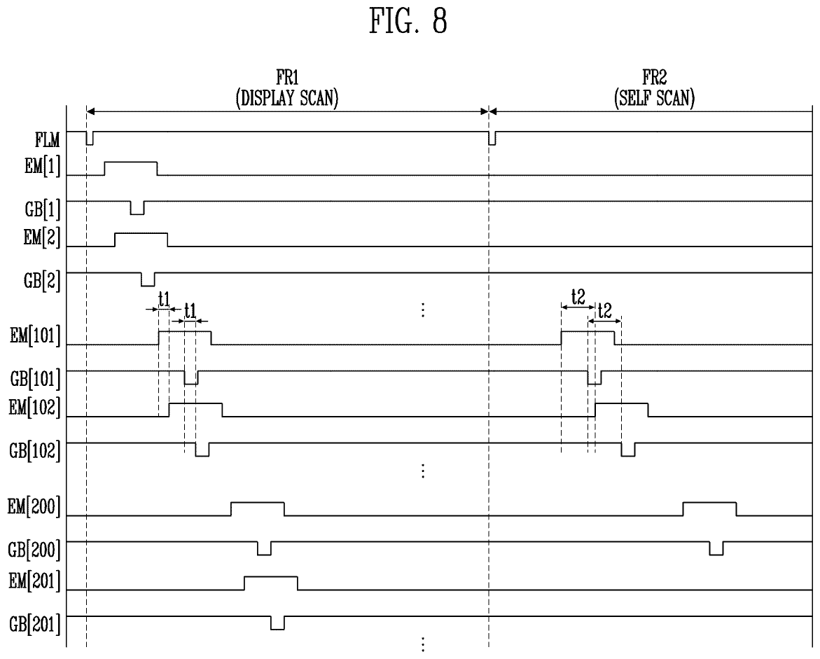

FIG. 7 is a diagram illustrating the sensing area of the display device shown in FIG. 1. FIG. 8 is a timing diagram illustrating the bias gate signal and the emission signal of the display device shown in FIG. 1.

For convenience of description, FIG. 7 illustrates that a sensing area FSA is included in pixel lines from a 101st first pixel line PL[101] to a 200th pixel line PL[200]. In FIG. 8, a start signal FLM indicates a start of one frame.

Referring to FIGS. 1, 2, 7, and 8, when the sensing area FSA is closer to an opposite end E2, which is opposite to one end E1 of the display area DA, than to the one end E1, the display panel driver may scan pixel lines from a pixel line close to the opposite end E2.

For example, the display panel driver may sequentially scan pixel lines from a first pixel line PL[1] to a 3080th pixel line PL[3080] in a frame (hereinafter, referred to as a first frame FR1) in which a display scan operation DISPLAY SCAN is performed. For example, the display panel driver may sequentially provide the gate signals GI[n], GC[n], GW[n], and GB[n] having an activation level and the emission signal EM[n] having a non-activation to the pixel lines from the first pixel line PL[1] to the 3080th pixel line PL[3080] in the first frame FR1.

For example, as shown in FIG. 8, the display panel driver may sequentially scan pixel lines from the 101st pixel line PL[101] to the 200th pixel line PL[200] in a frame (hereinafter, referred to as a second frame FR2) in which a self-scan operation SELF SCAN is performed. For example, the display panel driver may sequentially provide the bias gate signal GB[n] having an activation level and the emission signal EM[n] having a non-activation level to the pixel lines from the 101st pixel line PL[101] to the 200th pixel line PL[200] in the second frame FR2. However, the present disclosure is not limited to a scan direction.

The light sensor LS may provide a sensing signal of the sensing are FSA to the readout circuit 600 in response to the bias gate signal GB[n]. The bias gate signal GB[n] having an activation level may be provided to the sensing area FSA in the second frame FR2. In addition, the emission signal EM[n] having a non-activation level may be provided to the sensing area FSA in the second frame FR2.

In the first frame FR1, all pixel lines (e.g., the first to 3080th pixel lines PL[1] to PL[3030]) may be scanned for the purposed of writing of the data voltage VDATA (see FIG. 2).

In the self-scan operation SELF SCAN, the sub-pixel SP may continuously emit light even when the bias gate signal GB[n] having the activation level is not applied. Therefore, the display device may scan only the pixel lines (e.g., the 101st to 200th pixel lines PL[101] to PL[200]) including the sensing area FSA in the second frame FR2.

For example, as shown in FIG. 8, the bias gate signal GB[n] having the activation level may be applied to all the pixel lines in the first frame FR1. For example, as shown in FIG. 8, the bias gate signal GB[n] having the activation level may be applied to the pixel lines of the sensing area FSA in the second frame FR2.

For example, as shown in FIG. 8, the emission signal EM[n] having the non-activation level may be applied to all the pixel lines in the first frame FR1. For example, as shown in FIG. 8, the emission signal EM[n] having the non-activation level may be applied to the pixel lines of the sensing area FSA in the second frame FR2.

In one or more embodiments, respective timings, at which the bias gate signal GB[n] having the activation level and the emission signal EM[n] having the non-activation level are applied to a first pixel line (e.g., the 101st pixel line PL[101]) among the pixel lines of the sensing area FSA in the first frame FR1 and in the second frame FR2, may be the same.

The display panel driver may output the bias gate signal GB[n] having the activation level to the pixel lines in a first cycle t1 in the first frame FR1, and may output the bias gate signal GB[n] having the activation level to the pixel lines in a second cycle t2 longer than the first cycle t1 in the second frame FR2. The display panel driver may output the emission signal EM[n] having the non-activation level to the pixel lines in the first cycle t1 in the first frame FR1, and may output the emission signal EM[n] having the non-activation level to the pixel lines in the second cycle t2 longer than the first cycle t1 in the second frame FR2. For example, when the time of about 4 □ is suitable for the readout circuit 600 to convert a sensing signal into sensing information, the second cycle t2 may be about 4 □.

Because only the sensing area FSA is scanned in the second frame FR2, the display panel driver may output the bias gate signal GB[n] having the activation level and the emission signal EM[n] having the non-activation level to the pixel lines in a longer cycle. Accordingly, the display device can perform a sensing operation on the entire sensing area FSA during one frame. Thus, the sensing time can be reduced.

In one or more embodiments, a length of the first frame FR1 and a length of the second frame FR2 may be the same. For example, the display panel driver may not scan any pixel lines until a next frame starts after scanning of the sensing area FSA is terminated.

In one or more other embodiments, a length of the first frame FR1 and a length of the second frame FR2 may be different from each other. For example, when scanning of the sensing area FSA is terminated in the second frame FR2, the second frame FR2 may be terminated. For example, the processor may be set to output a vertical synchronization signal in a short cycle with respect to the second frame FR2 in which a sensing operation is performed. Because the length of the second frame FR2 in which the sensing operation is performed is shortened, the sensing time can be further reduced.

In one or more embodiments, the driving controller 200 may compensate for a luminance of the sensing area FSA. In the second frame FR2, the second initialization voltage VAINT and the bias voltage VBIAS may not be applied to sub-pixels SP of pixel lines (e.g., the first to 100th pixel lines PL[1] to PL[100] and the 201st to 3080th pixel lines PL[201] to PL[3080]) not including the sensing area FSA.

Therefore, a luminance difference may occur between the pixel lines not of the sensing area FSA and the pixel lines of the sensing area FSA. The driving controller 200 may compensate for a luminance of a data voltage VDATA provided to the sensing area FSA so as to compensate for the luminance difference. For example, the driving controller 200 may compensate for a data voltage VDATA provided to the pixel lines of the sensing area FSA so as to compensate for the luminance difference. In one or more other embodiments, the driving controller 200 may compensate for a luminance of the pixel lines not of the sensing area FSA so as to compensate for the luminance difference. For example, the driving controller 200 may compensate for a data voltage VDATA provided to the pixel lines not of the sensing area FSA so as to compensate for the luminance difference.

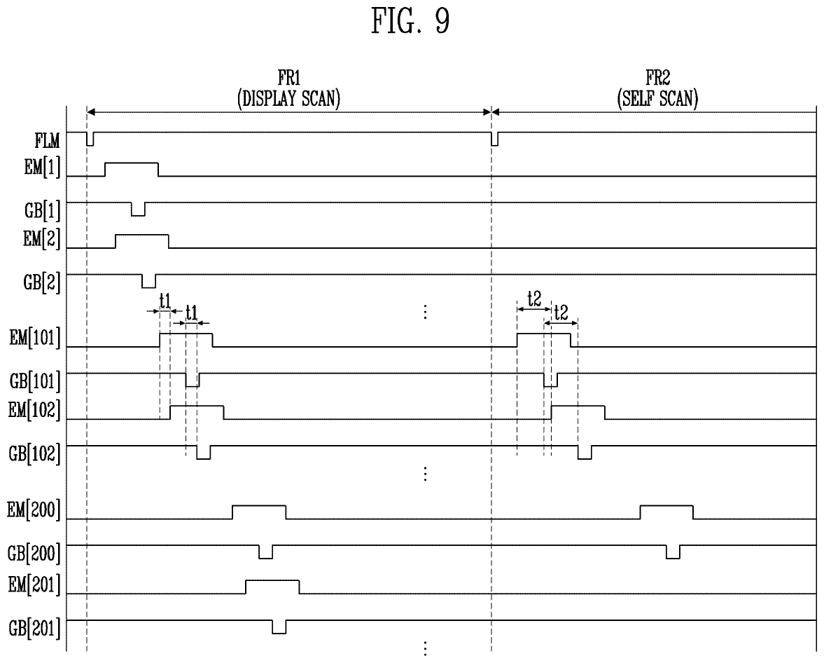

FIG. 9 is a timing diagram illustrating a bias gate signal and an emission signal of a display device in accordance with embodiments of the present disclosure.

The display device in accordance with these embodiments is configured substantially identical to the display device shown in FIG. 1, except for a scan start timing in the second frame FR2. Therefore, identical or similar components are designated by like reference numerals, and overlapping descriptions will be omitted.

Referring to FIGS. 7 and 9, a time at which the bias gate signal GB[n] having the activation level and the emission signal EM[n] having the non-activation level are applied to the first pixel line (e.g., the 101st pixel line PL[101]) among the pixel lines of the sensing area FSA in the second frame FR2 may be faster than a timing at which the bias gate signal GB[n] having the activation level and the emission signal EM[n] having the non-activation level are applied to the first pixel line (e.g., the 101st pixel line PL[101]) among the pixel lines of the sensing area FSA in the first frame FR1. Because only the sensing area FSA is scanned in the second frame FR2, the sensing area FSA may be first scanned when the second frame FR2 starts.

In one or more embodiments, a length of the first frame FR1 and a length of the second frame FR2 may be different from each other. For example, when scanning of the sensing area FSA is terminated in the second frame FR2, the second frame FR2 may be terminated. For example, the processor may be set to output a vertical synchronization signal in a short cycle with respect to the second frame FR2 in which a sensing operation is performed. Because the length of the second frame FR2 in which the sensing operation is performed is shortened, the sensing time can be further reduced.

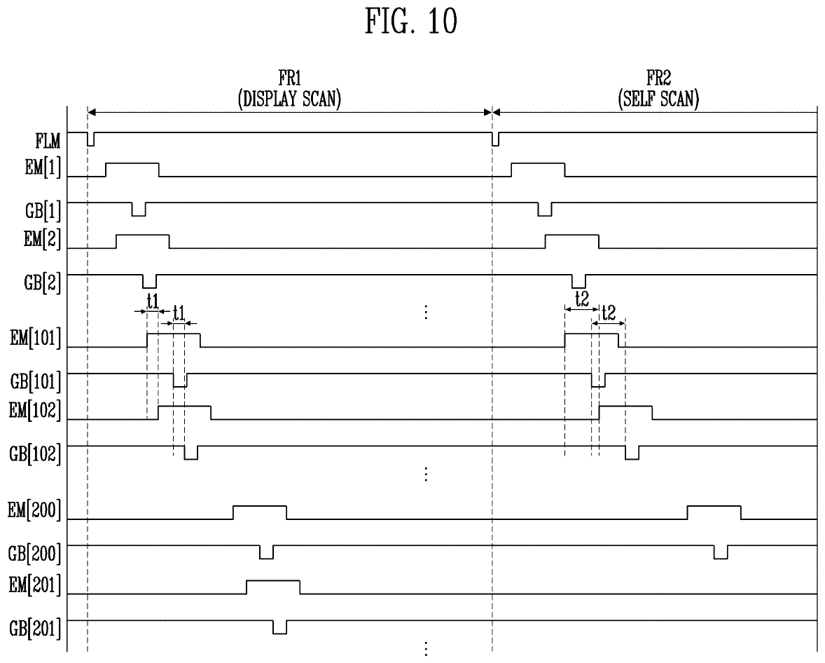

FIG. 10 is a timing diagram illustrating a bias gate signal and an emission signal of a display device in accordance with embodiments of the present disclosure.

The display device in accordance with these embodiments is configured substantially identical to the display device shown in FIG. 1, except for pixel lines scanned in the second frame FR2. Therefore, identical or similar components are designated by like reference numerals, and overlapping descriptions will be omitted.

Referring to FIGS. 1, 2, 7, and 10, the light sensor LS may provide the readout circuit 600 with a sensing signal of pixel lines from the first pixel line PL[1] to the pixel lines of the sensing area FSA in response to the bias gate signal GB[n]. The bias gate signal GB[n] having the activation level may be provided to the pixel lines from the first pixel line PL[1] to the pixel lines of the sensing area FSA in the second frame FR2. In addition, the emission signal EM[n] having the non-activation level may be provided to the pixel lines from the first pixel line PL[1] to the pixel lines of the sensing area FSA in the second frame FR2.

For example, as shown in FIG. 10, the bias gate signal GB[n] having the activation level may be applied to the pixel lines from the first pixel line PL[1] to the pixel lines of the sensing area FSA (e.g., from the first pixel line PL[1] to the 200th pixel line PL[200]) in the second frame FR2.

For example, as shown in FIG. 10, the emission signal EM[n] having the non-activation level may be applied to the pixel lines from the first pixel line PL[1] to the pixel lines of the sensing area FSA in the second frame FR2.

When the sensing area FSA is closer to the opposite end E2, which is opposite to the one end E1 of the display area DA, than to the one end E1, the display panel driver may scan pixel lines from a pixel line close to the opposite end E2. Thus, scanning starts from the first pixel line PL[1] close to the sensing area FSA instead of the 3080th pixel line PL[3080], so that the sensing time can be further reduced.

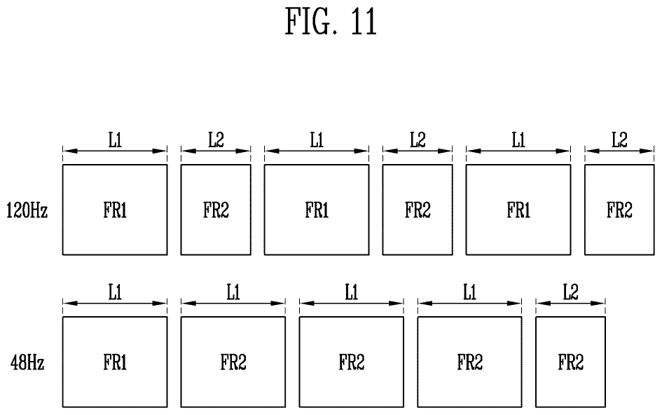

FIG. 11 is a diagram illustrating a length of a frame of a display device in accordance with embodiments of the present disclosure.

Referring to FIG. 11, the display panel driver may perform a sensing operation in any one of second frames FR2. A length of the second frame FR2 in which the sensing operation is performed may be shorter than a length of another frame. For example, when scanning of the sensing area FSA is terminated in the second frame FR2, the second frame FR2 may be terminated. Because the length of the second frame FR2 in which the sensing operation is performed is shortened, the sensing time can be further reduced.

For example, when the driving frequency is about 120 Hz, one driving frame may include one first frame FR1 and one second frame FR2, a length of the first frame FR1 may be a first length L1, and a length of the second frame FR2 may be a second length L2 that is shorter than the first length L1. For example, when the driving frequency is about 48 Hz, one driving frame may include one first frame FR1 and four second frames FR2, a length of the first frame FR1 may be the first length L1, a length of three second frames FR2 in which the sensing operation is not performed among the second frames FR2 may be the first length L1, and a length of the other second frame FR2 in which the sensing operation is performed among the second frames FR2 may be the second length L2.

In these embodiments, the sensing operation may be performed in the last second frame FR2 in one driving frame. However, the present disclosure is not limited thereto. For example, the sensing operation may be performed in a plurality of second frames FR2 in one driving frame. For example, the sensing operation may be performed in a first second frame FR2 in one driving frame.

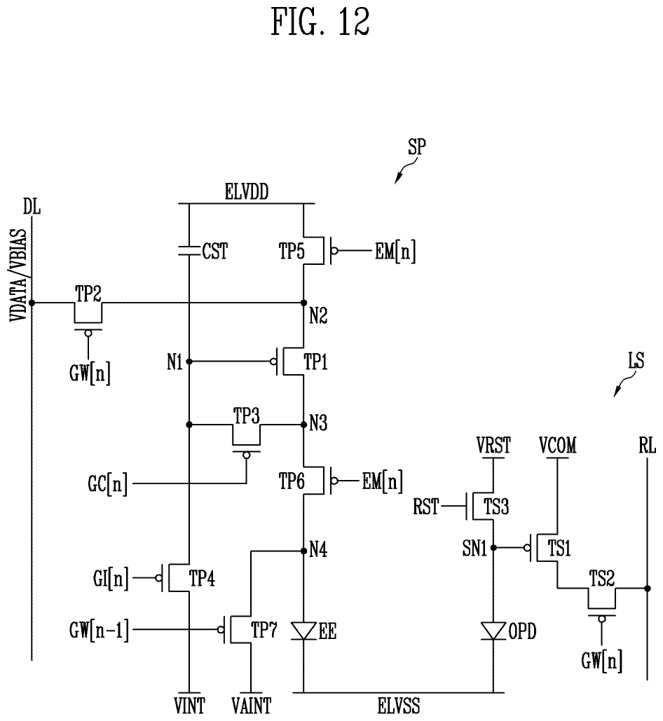

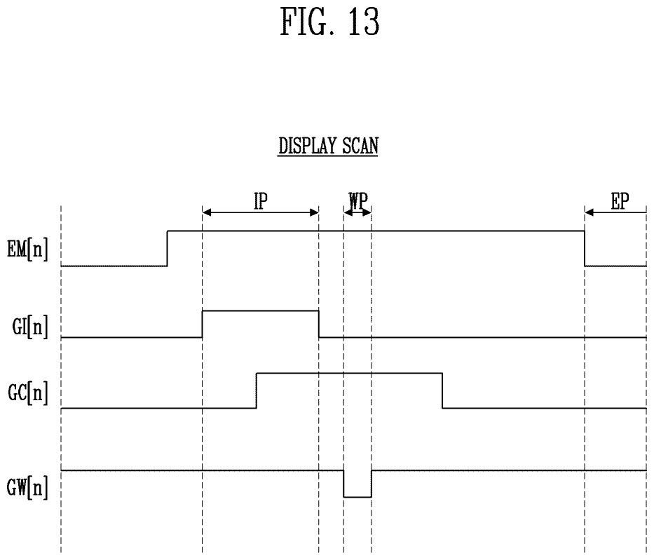

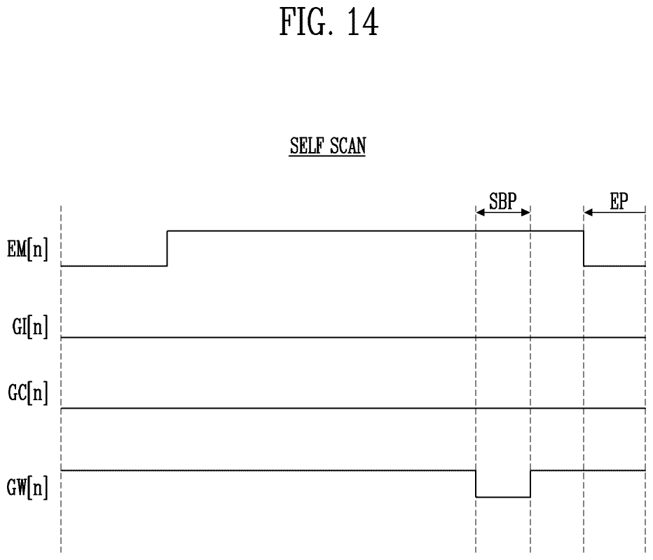

FIG. 12 is a circuit diagram illustrating a sub-pixel and a light sensor of a display device in accordance with embodiments of the present disclosure. FIG. 13 is a timing diagram illustrating one or more embodiments in which the display device shown in FIG. 12 performs a display scan operation. FIG. 14 is a timing diagram illustrating one or more embodiments in which the display device shown in FIG. 12 performs a self-scan operation.

The display device in accordance with these embodiments is configured substantially identical to the display device shown in FIG. 1, except that the display device of these embodiments does not include the eighth pixel transistor TP8 (see FIG. 2), the write gate signal GW[n] is applied to the control electrode of the second sensing transistor TS2, and a write gate signal GW[n−1] of a previous pixel line is applied to the control electrode of the seventh pixel transistor TP7. Therefore, identical or similar components are designated by like reference numerals, and overlapping descriptions will be omitted not to be repeated.

Referring to FIGS. 1 and 12, the data driver 400 may apply a data voltage VDATA to the data line DL in a first frame, and may apply the bias voltage VBIAS to the data line DL in a second frame. The second pixel transistor TP2 may provide the data voltage VDATA to the first pixel transistor TP1 in response to the write gate signal GW[n] in the first frame, and may provide the bias voltage VBIAS to the first pixel transistor TP1 in response to the write gate signal GW[n] in the second frame. The seventh pixel transistor TP7 may apply the second initialization voltage VAINT to the first electrode of the light-emitting element EE in response to the write gate signal GW[n−1] of the previous pixel line. The second sensing transistor TS2 may provide a sensing signal to the readout line RL in response to the write gate signal GW[n].

Referring to FIGS. 12 and 13, the first frame may include an initialization period IP, a writing period WP, an anode initialization period, and an emission period EP.

In the initialization period IP, the initialization gate signal GI[n] may have an activation level, and the fourth pixel transistor TP4 may be turned on. Accordingly, the first initialization voltage VINT may be applied to the first node N1. That is, the control electrode of the first pixel transistor TP1 (e.g., the storage capacitor CST) may be initialized.

In the anode initialization period, the write gate signal GW[n−1] of the previous pixel line may have an activation level, and the seventh pixel transistor TP7 may be turned on. Accordingly, the second initialization voltage VAINT may be applied to the first electrode of the light-emitting element EE.

In the writing period WP, the write gate signal GW[n] and the compensation gate signal GC[n] may have an activation level, and the second pixel transistor TP2 and the third pixel transistor TP3 may be turned on. Accordingly, the data voltage VDATA may be written in the storage capacitor CST.

The sub-pixel SP may emit light in response to the emission signal EM[n]. In the emission period EP, the emission signal EM[n] may have an activation level, and the fifth pixel transistor TP5 and the sixth pixel transistor TP6 may be turned on. Accordingly, the first power voltage ELVDD may be applied to the first pixel transistor TP1 such that a driving current is generated, and the driving current may be applied to the light-emitting element EE. That is, the light-emitting element EE may emit light with a luminance corresponding to the driving current.

Referring to FIGS. 12 and 14, the second frame may include a sensing bias period SBP, an anode initialization period, and an emission period EP.

In the sensing bias period SBP, the write gate signal GW[n] may have an activation level, and the second pixel transistor TP2 may be turned on. Accordingly, the bias voltage VBIAS may be applied to the first pixel transistor TP1.

In the sensing bias period SBP, the write gate signal GW[n] may have the activation level, and the second sensing transistor TS2 may be turned on. Accordingly, a sensing signal may be transferred to the readout line RL. In addition, the readout circuit 600 (see FIG. 1) may generate sensing information, based on the received sensing signal.

In the anode initialization period, the write gate signal GW[n−1] of the previous pixel line may have an activation level, and the seventh pixel transistor TP7 may be turned on. Accordingly, the second initialization voltage VAINT may be applied to the first electrode of the light-emitting element EE.

In the emission period EP, the emission signal EM[n] may have an activation level, and the fifth pixel transistor TP5 and the sixth pixel transistor TP6 may be turned on. Accordingly, the first power voltage ELVDD may be applied to the first pixel transistor TP1 such that a driving current is generated, and the driving current may be applied to the light-emitting element EE. That is, the light-emitting element EE may emit light with a luminance corresponding to the driving current.

As such, the display device may perform a sensing operation through the write gate signal GW[n], which has no influence on the data voltage VDATA written to the sub-pixel SP, in the second frame. Accordingly, influence that the sensing operation may have on the sub-pixel SP can be reduced or minimized.

The pixel circuit described with reference to FIGS. 12 to 14 may be applied to the embodiments described with reference to FIGS. 7 to 11, using the write gate signal GW[n] instead of the bias gate signal GB[n]. Therefore, overlapping descriptions will be omitted.

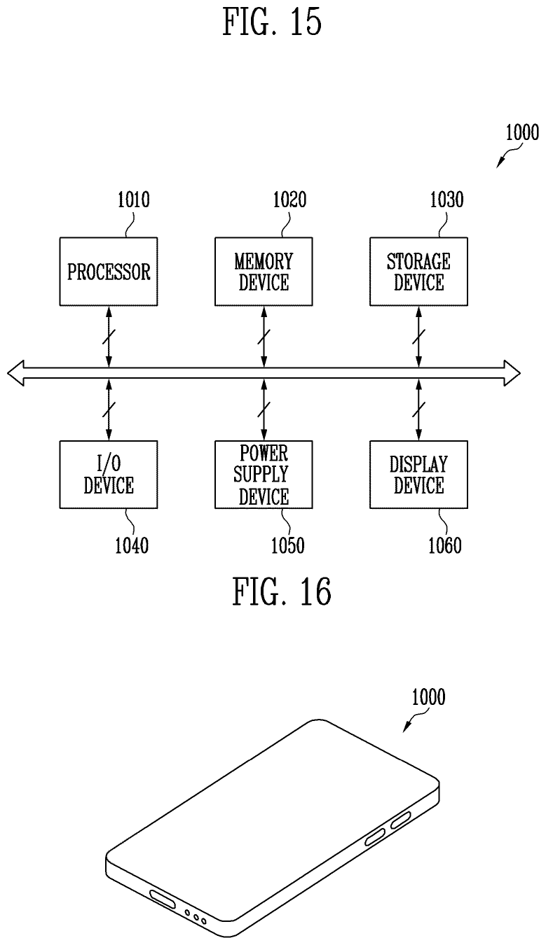

FIG. 15 is a block diagram illustrating an electronic device in accordance with embodiments of the present disclosure. FIG. 16 is a diagram illustrating one or more embodiments in which the electronic device shown in FIG. 15 is implemented as a smartphone.

Referring to FIGS. 15 and 16, the electronic device 1000 may include a processor 1010, a memory device 1020, a storage device 1030, an input/output (I/O) device 1040, a power supply, 1050, and a display device 1060. The display device 1060 may be the display device shown in FIG. 1. Also, the electronic device 1000 may further include several ports capable of communicating with a video card, a sound card, a memory card, a USB device, and the like, or communicating with other systems. In one or more embodiments, as shown in FIG. 16, the electronic device 1000 may be implemented as a smartphone. However, this is merely illustrative, and the electronic device 1000 is not limited thereto. For example, the electronic device 1000 may be implemented as a mobile phone, a video phone, a smart pad, a smart watch, a tablet PC, a vehicle navigation system, a computer monitor, a notebook computer, a head mounted display device, or the like.

The processor 1010 may perform specific calculations or tasks. In some embodiments, the processor 1010 may be a microprocessor, a central processing unit, an application processor, or the like. The processor 1010 may be connected to other components through an address bus, a control bus, a data bus, and the like. In some embodiments, the processor 1010 may be connected to an extension bus, such as a peripheral component interconnect (PCI) bus.

The memory device 1020 may store data necessary for an operation of the electronic device 1000. For example, the memory device 1020 may include a nonvolatile memory device, such as an Erasable Programmable Read-Only Memory (EPROM) device, an Electrically Erasable Programmable Read-Only Memory (EEPROM) device, a flash memory device, a Phase Change Random Access Memory (PRAM) device, a Resistance Random Access Memory (RRAM) device, a Nano Floating Gate Memory (NFGM) device, a Polymer Random Access Memory (PoRAM) device, a Magnetic Random Access Memory (MRAM) device, or a Ferroelectric Random Access Memory (FRAM) device, and/or a volatile memory device, such as a Dynamic Random Access Memory (DRAM) device, a Static Random Access Memory (SRAM) device, or a mobile DRAM device.

The storage device 1030 may include a Solid State Drive (SSD), a Hard Disk Drive (HDD), a CD-ROM, and the like.

The I/O device 1040 may include an input means, such as a keyboard, a keypad, a touch screen, or a mouse, and an output means, such as a speaker or a printer. In some embodiments, the display device 1060 may be included in the I/O device 1040.

The power supply 1050 may supply power necessary for an operation of the electronic device 1000. For example, the power supply 1050 may be a power management integrated circuit (PMIC).

The display device 1060 may display an image corresponding to visual information of the electronic device 1000. The display device 1060 may be an organic light-emitting display device or a quantum dot light-emitting display device, but the present disclosure is not limited thereto. The display device 1060 may be connected to other components through the buses or another communication link.

The electronic device 1000 according to one or more embodiments may a device that displays a moving image and/or a still image. The electronic device 1000 may be applied to portable electronic devices such as mobile phones, smartphones, tablet personal computers (PCs), mobile communication terminals, electronic notebooks, electronic books, portable multimedia players (PMPs), navigations, and ultra-mobile PCs (UMPCs). For example, the electronic device 1000 may be applied to a display unit of a television, a laptop computer, a monitor, a billboard, or the Internet of Things (IoT). Alternatively, in one or more embodiments, the electronic device 1000 may be applied to a smartwatch, a watch phone, a virtual reality (VR) device, an augmented reality (AR) device, and/or a head-mounted display device (HMD) (e.g., for implementing virtual reality and/or augmented reality).

In accordance with the present disclosure, the display device performs a sensing operation in a frame in which a self-scan operation is performed, so that a sensing time of a light sensor can be reduced.

Embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims, with functional equivalents thereof to be included therein.

What is claimed is:

1. A display device comprising:
a display panel comprising a sub-pixel, and a light sensor for generating a sensing signal corresponding to an amount of received light; and
a display panel driver for driving the display panel, for writing a data voltage to the sub-pixel in a first frame, and for receiving the sensing signal in a second frame.

2. The display device of claim 1, wherein the data voltage is not written in the second frame.

3. The display device of claim 1, wherein the sub-pixel comprises:
a first pixel transistor for generating a driving current corresponding to the data voltage;
an eighth pixel transistor for providing a bias voltage to the first pixel transistor in response to a bias gate signal; and
a light-emitting element emitting light by receiving the driving current.

4. The display device of claim 3, wherein the light sensor comprises:
a first sensing transistor for generating the sensing signal;
a second sensing transistor for providing the sensing signal to a readout line in response to the bias gate signal; and
a light-receiving element connected to a control electrode of the first sensing transistor.

5. The display device of claim 1, wherein the sub-pixel comprises:
a first pixel transistor for generating a driving current corresponding to the data voltage in the first frame;
a second pixel transistor for providing the data voltage to the first pixel transistor in response to a write gate signal in the first frame, and for providing a bias voltage to the first pixel transistor in response to the write gate signal in the second frame; and
a light-emitting element for emitting light by receiving the driving current.

6. The display device of claim 5, wherein the light sensor comprises:
a first sensing transistor for generating the sensing signal;
a second sensing transistor for providing the sensing signal to a readout line in response to the write gate signal; and
a light-receiving element connected to a control electrode of the first sensing transistor.

7. The display device of claim 1, wherein the light sensor is configured to provide the sensing signal to the display panel driver in response to a gate signal,
wherein the display panel comprises a sensing area, and
wherein the gate signal having an activation level is provided to the sensing area in the second frame.

8. The display device of claim 7, wherein the display panel driver is configured to output the gate signal having the activation level to pixel lines in a first cycle in the first frame, and is configured to output the gate signal having the activation level to the pixel lines in a second cycle, which is longer than the first cycle, in the second frame.

9. The display device of claim 7, wherein the sensing area comprises pixel lines from an nth pixel line to an mth pixel line, and
wherein the gate signal having the activation level is applied to the pixel lines from the nth pixel line to the mth pixel line in the second frame.

10. The display device of claim 9, wherein the gate signal having the activation level is applied to pixel lines from a first pixel line to an (n−1)th pixel line in the second frame.

11. The display device of claim 9, wherein timings at which the gate signal having the activation level is applied to the nth pixel line in the first frame and in the second frame are substantially the same.

12. The display device of claim 9, wherein a timing at which the gate signal having the activation level is applied to the nth pixel line in the second frame is faster than a timing at which the gate signal having the activation level is applied to the nth pixel line in the first frame.

13. The display device of claim 7, wherein the sub-pixel is configured to emit light in response to an emission signal, and
wherein the emission signal having a non-emission level is provided to the sensing area in the second frame.

14. The display device of claim 13, wherein the display panel driver is configured to output the emission signal having a non-activation level to pixel lines in a first cycle in the first frame, and is configured to output the emission signal having the non-activation level to the pixel lines in a second cycle, which is longer than the first cycle, in the second frame.

15. The display device of claim 7, wherein, the sensing area is closer to an opposite end, which is opposite to one end of the display panel, than to the one end, and
wherein the display panel driver is configured to scan pixel lines from a pixel line adjacent the opposite end.

16. The display device of claim 7, wherein the display panel driver is configured to compensate for a luminance of the sensing area.

17. The display device of claim 7, wherein the display panel driver is configured to receive the sensing signal of the sensing area of the display panel in the second frame,
wherein the second frame is terminated upon termination of scanning of the sensing area, and
wherein a length of the first frame is different from a length of the second frame.

18. The display device of claim 1, wherein a length of the first frame is substantially equal to a length of the second frame,
wherein a driving frame comprises the first frame and multiple second frames comprising the second frame, and
wherein the display panel driver is configured to receive the sensing signal from at least one of the second frames.

19. An electronic device comprising a display device comprising:
a display panel comprising a sub-pixel, and a light sensor for generating a sensing signal corresponding to an amount of received light; and
a display panel driver for driving the display panel, for writing a data voltage to the sub-pixel in a first frame, and for receiving the sensing signal in a second frame.

20. The electronic device of claim 19, wherein the electronic device comprises a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, a head-mounted display (HMD), a virtual reality (VR) device, or an augmented reality (AR) device.
